(19) United States
(12) Patent Application Publication
(10) Pub. No.: US 2003/0099001 A1
(43) Pub. Date: May 29, 2003

(54) Image processing system, image pick-up apparatus, image processing apparatus, image processing method, and computer-readable medium storing program

(75) Inventors: Mikio Watanabe, Saitama (JP); Hisayoshi Tsubaki, Saitama (JP); Kazuhiko Takemura, Saitama (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/301,807

(22) Filed: Nov. 22, 2002

(30) Foreign Application Priority Data
Nov. 22, 2001 (JP) 2001-358165

(51) Int. Cl. H04N 1/21; H04N 1/40

(52) U.S. Cl. 358/462; 358/302

(57) ABSTRACT

An image processing system which appropriately performs image processing on an image picturized by an image pick-up apparatus. The image processing system includes an image pick-up apparatus and an image processing apparatus. The image pick-up apparatus includes an image pick-up unit which picturizes an image of a subject, an image processing unit which performs image processing, a storing unit which stores processing level of the image processing in association with the image, the image processing being performed by the image processing unit, and an output unit which outputs the image and the processing level in association with the image, to the image processing apparatus. The image processing apparatus includes an acquisition unit which acquires the processing level in association with the image from the image pick-up apparatus, an image processing unit which performs image processing, and a control unit which controls processing level of image processing performed by the image processing unit based on the processing level of image processing performed by the image pick-up apparatus.

This patent application claims priority based on Japanese patent applications, 2001-358165 filed on Nov. 22, 2001, the contents of which are incorporated herein by reference.

### BACKGROUND OF THE INVENTION

1. Field of the Invention

The present invention relates to an image processing system, an image pick-up apparatus, an image processing apparatus, an image processing method, and a computer-readable medium storing program. More particularly, the present invention relates to the image processing system which can perform image processing appropriately on the image which is picturized by the image pick-up apparatus.

2. Description of the Related Art

A conventional image pick-up apparatus records image pick-up condition information, which indicates image pick-up conditions showing a state, etc. of the image pick-up apparatus when picturizing an image of a subject, and outputs the image and the image pick-up condition information in association with the image. A conventional image processing apparatus also performs image processing on the image based on the image and the image pick-up condition information which were received from the image pick-up apparatus.

However, a judgment method and judgment criteria of the image pick-up apparatus differ with manufacturers or models. Therefore, there is a problem that the image processing apparatus may unable to perform appropriate image processing on the image depending on manufacturers or models of the image pick-up apparatus which picturizes the image, when the image processing is performed based on the image pick-up condition information received from the image pick-up apparatus.

### SUMMARY OF THE INVENTION

Therefore, it is an object of the present invention to provide an image processing system, an image pick-up apparatus, an image processing apparatus, an image processing method, and a computer-readable medium storing program which can solve the foregoing problem. The above and other subjects can be achieved by combinations described in the independent claims. The dependent claims define further advantageous and exemplary combinations of the present invention.

According to the first aspect of the present invention, there is provided an image processing system including an image pick-up apparatus which picturizes an image of a subject, and an image processing apparatus which performs image processing on the image picturized by the image pick-up apparatus. The image pick-up apparatus includes an image pick-up unit which picturizes an image of the subject, an image processing unit which performs image processing on the image, a storing unit which stores processing level of the image processing in association with the image, the image processing being performed by the image processing unit, and an output unit which outputs the image and the processing level in association with the image to the image processing apparatus. The image processing apparatus includes an acquisition unit which acquires the image and the processing level in association with the image from the image pick-up apparatus, an image processing unit which performs image processing on the image, and a control unit which controls processing level of image processing performed by the image processing unit based on the processing level of image processing performed by the image pick-up apparatus.

According to the second aspect of the present invention, there is provided an image pick-up apparatus which picturizes an image of a subject. The image pick-up apparatus includes an image pick-up unit which picturizes the image of the subject, an image processing unit which performs image processing on the image, and a storing unit which stores processing level of the image processing in association with the image, the image processing being performed by the image processing unit.

The image processing unit may perform at least one processing of a contrast enhancement, a color gain correction, and a sharpness enhancements on the image, and the storing unit may store at least one of the processing level of the contrast enhancement, the color gain correction, and the sharpness enhancement, in association with the image, the image processing being performed by the image processing unit. The image pick-up apparatus may include a conversion unit which converts the processing level of the contrast enhancement and a color gain correction, performed by the image processing unit, into gamma correction level of the image, and the storing unit may store the gamma correction level as the processing level of the contrast enhancement and the color gain correction performed by the image processing unit.

The image pick-up apparatus may include a subject identification unit which identifies classification of the subject, and the storing unit may further store the classification of the subject, identified by the subject identification unit, in association with the image. The image pick-up apparatus may further include an image pick-up condition judging unit which judges image pick-up conditions when the image pick-up unit picturizes the image, and the storing unit may further store image pick-up condition information, which indicates the image pick-up conditions judged by the image pick-up condition judging unit, in association with the image. The image pick-up condition judging unit may acquire the sensitivity of the image pick-up unit as the image pick-up conditions, and the storing unit may further store sensitivity information, which indicates the sensitivity acquired by the image pick-up condition judging unit, in association with the image. The image pick-up apparatus may further include an output unit which outputs the image and the processing level in association with the image.

According to the third aspect of the present invention, there is provided an image processing apparatus which performs image processing on an image picturized by an image pick-up apparatus. The image processing apparatus includes an acquisition unit which acquires the image and processing level of image processing in association with the image, the image processing being performed on the image by the image pick-up apparatus, an image processing unit which performs image processing on the image, and a control unit which controls processing level of image processing performed by the image processing unit based on the processing level of image processing performed by the image pick-up apparatus.

The acquisition unit may acquire at least one processing level of a contrast enhancement, a color gain correction, and a sharpness enhancement, which is performed on the image by the image pick-up apparatus. If the processing level acquired by the acquisition unit is lower than a predetermined processing level, the control unit may enlarge the processing level of image processing performed by the image processing unit. The acquisition unit may further acquire classification of a subject of the image in association with the image, and the control unit may control the processing level of image processing performed by the image processing unit further based on the classification of the subject.

The image processing apparatus may further include a subject identification unit which identifies the classification of a subject of the image, and the control unit may control the processing level of image processing performed by the image processing unit further based on the classification of the subject identified by the subject identification unit. The acquisition unit may further acquire image pick-up condition information in association with the image, the image pick-up condition indicating image pick-up conditions when the image is picturized by the image pick-up apparatus, and the control unit may control the processing level of image processing performed by the image processing unit further based on the image pick-up condition information. The image processing apparatus may further include a printing unit which prints the image on which image processing is performed by the image processing unit. The image processing apparatus may further include a displaying unit which displays the image on which image processing is performed by the image processing unit.

According to the fourth aspect of the present invention, there is provided an image processing apparatus which performs image processing on an image picturized by an image pick-up apparatus. The image processing apparatus includes an image processing unit which performs image processing on the image, a subject identification unit which identifies classification of a subject of the image, and a control unit which controls processing level of image processing performed by the image processing unit based on the classification of the subject identified by the subject identification unit. The subject identification unit may identify classification of a main subjects of the image, and the control unit may control the processing level of image processing performed by the image processing unit based on the classification of the main subjects identified by the subject identification unit.

According to the fifth aspect of the present invention, there is provided an image processing apparatus which performs image processing on an image picturized by an image pick-up apparatus. The image processing apparatus includes an acquisition unit which acquires the image and sensitivity information in association with the image, the sensitivity information indicating sensitivity of the image pick-up apparatus when the image is picturized, and a noise reduction processing unit which performs noise reduction processing on the image based on the sensitivity information. If the sensitivity, indicated in the sensitivity information acquired by the acquisition unit acquired, is higher than a predetermined value, the noise reduction processing unit may perform noise reduction processing, such as high pass filtering and coring, on the image.

According to the sixth aspect of the present invention, there is provided an image processing method which performs image processing on an image picturized by an image pick-up apparatus. The image processing method includes steps of acquiring the image and processing level of image processing in association with the image, the image processing being performed on the image by the image pick-up apparatus, performing image processing on the image, and controlling processing level of image processing performed in the performing step based on the processing level of image processing performed by the image pick-up apparatus.

According to the seventh aspect of the present invention, there is provided an image processing method which performs image processing on an image picturized by an image pick-up apparatus. The image processing method includes steps of performing image processing on the image, identifying classification of a subject of the image, and controlling processing level of image processing performed in the performing step based on the classification of the subject identified in the identifying step.

According the eighth aspect of the present invention, there is provided an image processing method which performs image processing on an image picturized by an image pick-up apparatus. The image processing method includes steps of acquiring the image and sensitivity information in association with the image, the sensitivity information indicating sensitivity of the image pick-up apparatus when the image is picturized, and performing noise reduction processing on the image based on the sensitivity information.

According to the ninth aspect of the present invention, there is provided a computer readable medium storing thereon a program for an image pick-up apparatus which picturizes an image of a subject. The program includes an image pick-up module which allows the image pick-up apparatus to picturize an image of the subject, an image processing module which allows the image pick-up apparatus to perform image processing on the image, and a storing module which allows the image pick-up apparatus to store processing level of image processing in association with the image, the image processing being performed by the image processing module.

According to the tenth aspect of the present invention, there is provided a computer readable medium storing thereon a program for an image processing apparatus which performs image processing on an image picturized by an image pick-up apparatus. The program includes an acquisition module which allows the image processing apparatus to acquire the image and processing level of image processing in association with the image, the image processing being performed on the image by the image pick-up apparatus, an image processing module which allows the image processing apparatus to perform image processing on the image, and a control module which allows the image processing apparatus to control processing level of image processing performed by the image processing module based on the processing level of image processing performed by the image pick-up apparatus.

According to the eleventh aspect of the present invention, there is provided a computer readable medium storing thereon a program for an image processing apparatus which performs image processing on an image picturized by an image pick-up apparatus. The program includes an image processing module which allows the image processing apparatus to perform image processing on the image, a subject identification module which allows the image processing apparatus to identify classification of a subject of the image, and a control module which allows the image processing apparatus to control processing level of image processing performed by the image processing module based on the classification of the subject identified by the subject identification module.

According to the twelfth aspect of the present invention, there is provided a computer readable medium storing thereon a program for an image processing apparatus which performs image processing on an image picturized by an image pick-up apparatus. The program includes an acquisition module which allows the image processing apparatus to acquire the image and sensitivity information in association with the image, the sensitivity information indicating sensitivity of the image pick-up apparatus when the image is picturized, and a noise reduction processing module which allows the image processing apparatus to perform noise reduction processing on the image based on the sensitivity information.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a schematic illustration showing an image processing system according to an embodiment of the present invention.

FIG. 2 is a block diagram showing an example of a functional configuration of a digital camera according to the present embodiment.

FIG. 3 is a table showing an example of a data format outputted from an output unit.

FIG. 4 is a block diagram showing an example of a functional configuration of a printer according to the present embodiment.

FIG. 5 is a flow chart showing an example of operation of the printer according to the present embodiment.

FIG. 6 is a block diagram showing an example of a hardware configuration of a personal computer according to the present embodiment.

FIG. 7 is a block diagram showing an example of a detailed configuration of the digital camera according to the present embodiment.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

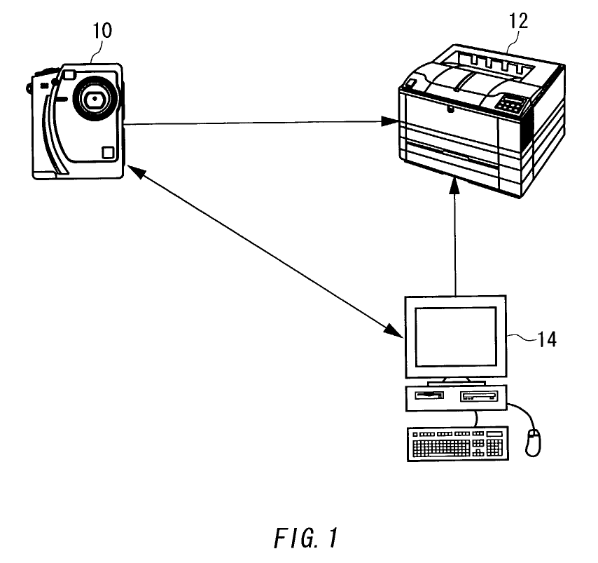

FIG. 1 is a schematic illustration showing an image processing system according to an embodiment of the present invention. The image processing system includes a digital camera 10, a printer 12, and a personal computer 14. The digital camera 10, the printer 12, and the personal computer 14 communicate with each other through a data transmission line. The data transmission line is, for example, a cable communications medium, such as IEEE1394 or USB, or a radio communications medium, such as IrDA, Bluetooth or wireless LAN. The data transmission line may be a network which includes a plurality of cable-communications media and radio-communications media, e.g., the Internet. A record medium, such as removable medium, may be used for delivery of the data among the digital camera 10, the printer 12, and the personal computer 14.

The digital camera 10 picturizes an image of a subject and transmits the picturized image data to the printer 12 or the personal computer 14. The digital camera 10 also attaches an image pick-up conditions to the image data, the image pick-up conditions indicating a state of the digital camera 10 or the like when picturizing the image of the subject, and transmits it to the printer 12 or the personal computer 14. The printer 12 or the personal computer 14 performs predetermined image processing on the received image data, and outputs the image data. That is, the printer 12 prints the image data, and the personal computer 14 outputs the image data to a display. The personal computer 14 transmits setting information to the digital camera 10 or the printer 12, and changes the setting information of the digital camera 10 or the printer 12.

The digital camera 10 is an example of an image pick-up apparatus and/or an image processing apparatus, and the printer 12 and the personal computer 14 are examples of image processing apparatuses. The image pick-up apparatus may be a digital still camera which photographs a still image, and may be a digital camcorder which photographs a dynamic image. The image processing apparatus may be a printer for a photo processing shop, which automatically adjusts quality of the image photographed by the digital camera, and prints the image.

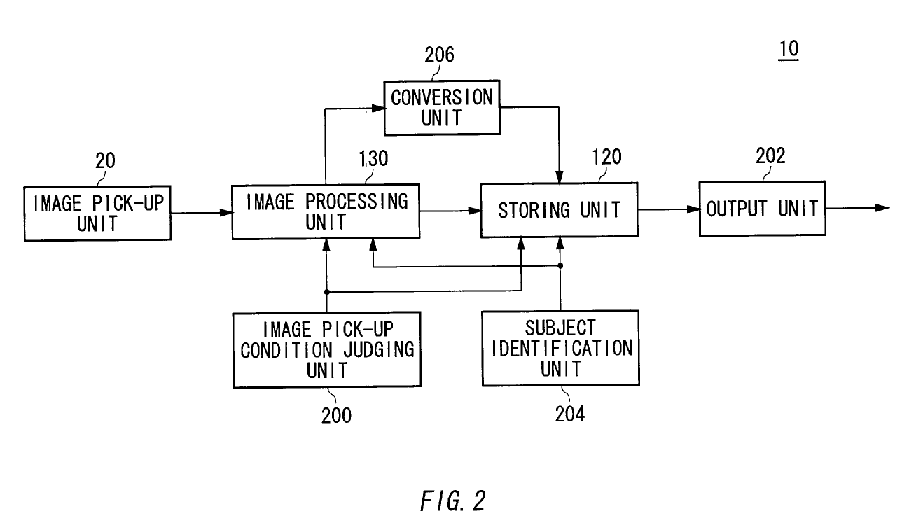

FIG. 2 is a block diagram showing an example of a functional configuration of the digital camera 10 according to the present embodiment. The digital camera 10 includes an image pick-up unit 20, an image processing unit 130, a storing unit 120, an output unit 202, a subject identification unit 204, an image pick-up condition judging unit 200, and a conversion unit 206.

The image pick-up unit 20 picturizes an image of a subject. The image pick-up condition judging unit 200 judges image pick-up conditions at the time of the image pick-up unit 20 picturizing the image. Specifically, the image pick-up condition judging unit 200 judges brightness of the subject, whether a flash is used or not, subject distance, a focal length, sensitivity, etc. Then the image processing unit 130 performs image processing on the image picturized by the image pick-up unit 20 based on the judging result of the image pick-up condition judging unit 200. Then the image processing unit 130 outputs processing levels of the image processing performed on the image to the storing unit 120.

Specifically, the image processing unit 130 performs at least one processing of contrast enhancement, color gain correction, and sharpness enhancement, on the image picturized by the image pick-up unit 20. Then the image processing unit 130 outputs the processing levels to the storing unit 120, i.e., the contrast enhancement, the color gain correction, and the sharpness enhancement, which are performed on the image. For example, the processing levels of the contrast enhancement, the color gain correction, and the sharpness enhancement, indicate how much the image processing is performed compared with standard processing level for an image of standard output profile of the image pick-up apparatus. That is, when profile of the image, on which the image processing is performed by the image processing unit 130, i.e., contrast, color gain, and sharpness, is higher than the standard output profile, the processing level is “high”, when the profile of the image is lower than the standard output profile, the processing level is “low”, or when the profile of the image is approximately the same as the standard output profile, the processing level is “standards”. It is preferable that the processing level of the contrast enhancement, the color gain correction, and the sharpness enhancement, are chosen from three or more levels. For example, the standard output profile is a standard color space profile (sRGB).

The subject identification unit 204 identifies classification of the subject of the image picturized by the image pick-up unit 20. Specifically, the subject identification unit 204 identifies the classification of a main subject of the image picturized by the image pick-up unit 20, and classification of a scene. For example, the classification of the main subject is selected from a person, a building, a flower, etc., and the classification of the scene is selected from a landscape, a night scene, a twilight scene, a snowscape, etc. The subject identification unit 204 may select the classification of the subject based on photography mode of the digital camera 10 manually, or based on automatic image recognition.

The storing unit 120 stores the processing level of the image processing performed by the image processing unit 130 in association with the image picturized by the image pick-up unit 20. Specifically, The storing unit 120 stores at least one processing level of the contrast enhancement, the color gain correction, and the sharpness enhancement in association with the image picturized by the image pick-up unit 20. The storing unit 120 also stores the classification of the subject identified by the subject identification unit 204 in association with the image picturized by the image pick-up unit 20. The storing unit 120 also stores image pick-up condition information, which is judged by the image pick-up condition judging unit 200, such as brightness of the subject, whether a flash is used or not, subject distance, a focal length and sensitivity, in association with the image picturized by the image pick-up unit 20.

The storing unit 120 may further store a disable flag in association with the image, the disable flag indicating whether to disable image processing in an external image processing apparatus, such as the printer 12, based on the classification of the subject identified by the subject identification unit 204, the processing level of the image processing performed by the image processing unit 130, and the image pick-up condition judged by the image pick-up condition judging unit 200. The storing unit 120 may store the disable flag based on a directions of a user. Further, the digital camera 10 may have means for detecting malfunction of the subject identification unit 204, the image processing unit 130, or the image pick-up condition judging unit 200, and the storing unit 120 may store the disable flag when the malfunction of the image processing unit 130 or the image pick-up condition judging unit 200 is detected.

The conversion unit 206 may convert the processing level of the contrast enhancement and the color gain correction by the image processing unit 130, into gamma correction level of the image. The storing unit 120 may store the gamma correction level outputted from the conversion unit 206 as the processing level of the contrast enhancement and the color gain correction by the image processing unit 130. The conversion unit 206 may convert sensitivity of the image pick-up unit 20 judged by the image pick-up condition judging unit 200 into a gamma characteristic.

The output unit 202 outputs the image stored in the storing unit 120 to the external apparatus such as a memory card or the printer 12. The output unit 202 also outputs the classification of the subject identified by the subject identification unit 204, the image pick-up condition judged by the image pick-up condition judging unit 200 and the processing level of the image processing performed by the image processing unit 130 in association with the image data so that the external image processing apparatus, such as the printer 12, can perform appropriate image processing.

In another examples, the image processing unit 130 outputs difference information to the storing unit 120, the difference information indicating difference between an image which the output unit 202 is to output, and the image which the output unit 202 outputs actually, as a processing level of the image processing performed on the image. Then the storing unit 120 stores the image and the difference information in association with the image. The output unit 202 outputs the image and the difference information in association with the image to an external apparatus. The image, which the output unit 202 is to output, has the standard color space profile (sRGB).

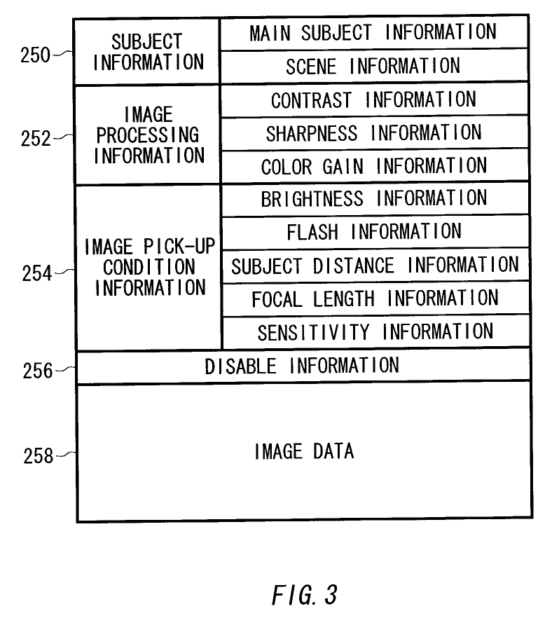

FIG. 3 is a table showing an example of a data format outputted from the output unit 202. The data outputted from the output unit 202 has tag information including subject information 250, image processing information 252, image pick-up condition information 254 and disable information 256, and image data 258. The subject information 250 includes main subject information and scene information. The main subject information indicates the classification of the main subjects of the image of the image data 258. For example, the main subject information is selected from a person, a building, a flower, etc. The scene information indicates the classification of the scene of the image of the image data 258. For example, the scene information is selected from a landscape, a night scene, a twilight scene, a snowscape, etc.

The image processing information 252 includes contrast information, sharpness information, and color gain information. Each of the contrast information, i.e., the sharpness information, and the color gain information indicates each processing level of the contrast enhancement, the sharpness enhancement, and the color gain correction performed on the image by the image processing unit 130.

The image pick-up condition information 254 includes brightness information, flash information, subject distance information, focal length information, and sensitivity information. The brightness information indicates brightness of the subject. The flash information indicates whether the flash is used during the image pick-up. The subject distance information indicates distance between the digital camera 10 and the subject during the image pick-up. The focal length information indicates focal length during the image pick-up. The sensitivity information indicates sensitivity of the image pick-up unit 20. For example, the sensitivity information indicates value of ISO sensitivity.

The disable information 256 is a disable flag indicating whether to disable image processing in the printer 12 based on the subject information 250, the image processing information 252, and the image pick-up condition information 254. The image data 258 is data in which the image is stored, e.g., data in JPEG form.

The digital camera 10 of the present embodiment can supply the information to the printer 12, i.e., the classification of the subject, the image pick-up conditions, and the processing level of the image processing, in association with the image. Therefore, the printer 12 can perform image processing appropriately on the image by utilizing the information, such as the classification of the subject, the image pick-up conditions, and the processing level of the image processing acquired from the digital camera 10.

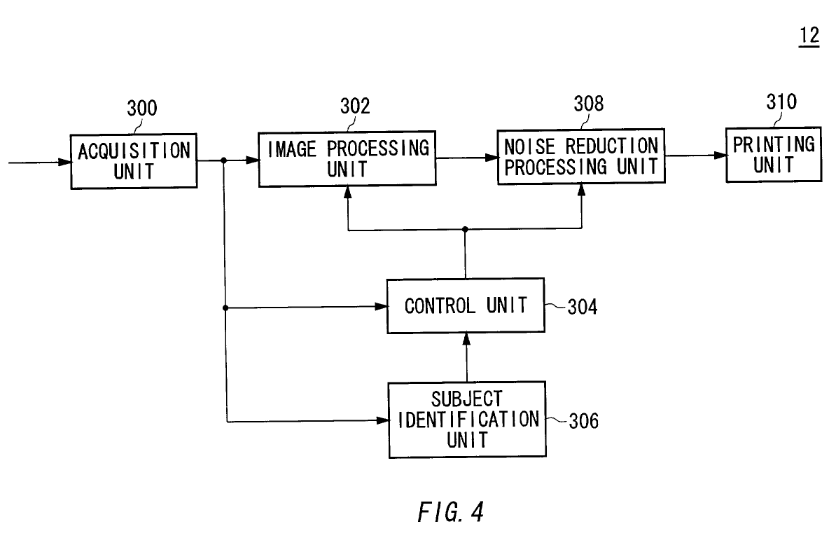

FIG. 4 is a block diagram showing an example of a functional configuration of the printer 12 according to the present embodiment. The printer 12 includes an acquisition unit 300, an image processing unit 302, a control unit 304, a subject identification unit 306, a noise reduction processing unit 308, and a printing unit 310.

The acquisition unit 300 acquires the image and the image processing information in association with the image from an external apparatus, such as a memory card or the digital camera 10, the image processing information indicating the processing level of the image processing performed on the image in the digital camera 10. Specifically, the acquisition unit 300 acquires at least one processing level of the contrast enhancement, the color gain correction, or the sharpness enhancement, as the processing level of the image processing performed on the image in the digital camera 10. The acquisition unit 300 also acquires the image pick-up condition information in association with the image, the image pick-up condition information indicating the image pick-up conditions when the image is picturized by the digital camera 10. The acquisition unit 300 may further acquire the subject information indicating the classification of the subject of the image. The acquisition unit 300 may acquire the disable information indicating whether to disable the image processing based on the subject information, the image processing information and the image pick-up condition information.

The control unit 304 controls the processing level of the image processing by the image processing unit 302, based on the processing level of the image processing performed in the digital camera 10 on the image acquired by the acquisition unit 300. Specifically, when the processing level of the image processing performed on the image in the digital camera 10 is lower than a predetermined level, the control unit 304 preferably enlarges the processing level performed by the image processing unit 302. When the processing level of the image processing performed on the image in the digital camera 10 is higher than a predetermined level, the control unit 304 preferably lowers the processing level performed by the image processing unit 302. More specifically, when the processing level of the image processing performed on the image in the digital camera 10 is “low”, the control unit 304 preferably enlarges, or disables, the processing level performed by the image processing unit 302. When the processing level of the image processing performed on the image in the digital camera 10 is “high”, the control unit 304 preferably lowers, or disables, the processing level performed by the image processing unit 302. The control unit 304 analyzes characteristic of the image acquired by the acquisition unit 300, and controls the processing level of the image processing performed by the image processing unit 302 based on the characteristic of the image.

The control unit 304 also controls the processing level of the image processing performed by the image processing unit 302 based on the image pick-up conditions acquired by the acquisition unit 300. The control unit 304 also controls the processing level of the image processing performed by the image processing unit 302 based on the classification of the subject of the image acquired by the acquisition unit 300. For example, when the classification of the main subjects of the image is a person, the control unit 304 controls the image processing unit 302 to lower the processing level of the sharpness enhancement, enlarge the processing level of the color gain correction including saturation enhancement, white balance correction, etc., and lower the processing level of the contrast enhancement. When the classification of the scene is a night scene, the control unit 304 controls the image processing unit 302 to enlarge the processing level of the color gain correction, and enlarge the processing level of the contrast enhancement.

The control unit 304 also controls whether to perform the noise reduction processing on the image by the noise reduction processing unit 308 based on the sensitivity of the digital camera 10, which is one of the image pick-up conditions acquired by the acquisition unit 300. When the sensitivity acquired by the acquisition unit 300 is higher than a predetermined value, the control unit 304 controls the noise reduction processing unit 308 to perform noise reduction processing on the image.

The subject identification unit 306 identifies the classification of the subject of the image by the image recognition etc., when the acquisition unit 300 does not acquire the classification of the subject of the image. The subject identification unit 306 may identify the classification of the subject of the image based on such as spatial frequency, color gain, and contrast of the image. Specifically, the subject identification unit 306 identifies the classification of the main subjects of the image, and the classification of the scene. Then the control unit 304 controls the processing level of the image processing performed by the image processing unit 302 based on the classification of the main subjects of the image and/or the classification of the scene identified by the subject identification unit 306.

The image processing unit 302 performs image processing on the image acquired by the acquisition unit 300 based on directions of the control unit 304. The noise reduction processing unit 308 also performs noise reduction processing such as high pass filtering and/or coring on the image acquired by the acquisition unit 300 based on the directions of the control unit 304. Then the printing unit 310 prints the image, on which the image processing and the noise reduction processing have been performed by the image processing unit 302 and the noise reduction processing unit 308.

In another example, the acquisition unit 300 acquires difference information indicating difference between the image which is to be acquired, and the image which is acquired actually. Then the control unit 304 controls the processing level of the image processing performed by the image processing unit 302 based on the difference information acquired by the acquisition unit 300. The acquisition unit 300 may acquire gamma characteristic difference information which indicates difference between the gamma characteristic of the image which is to be acquired, and the gamma characteristic of the actually acquired image. Then the control unit 304 may control the processing level of the image processing performed by the image processing unit 302 based on the gamma characteristic difference information acquired by the acquisition unit 300. The image, which the acquisition unit 300 is to acquire, has a standard color space profile (sRGB).

The printer 12 of the present embodiment can appropriately perform image processing on the image by utilizing the information, such as the classification of the subject, the image pick-up condition, and the processing level of the image processing, which are acquired from the digital camera 10. Since the printer 12 of the present embodiment performs the noise reduction processing on the image when the sensitivity of the digital camera 10, which picturized the image, is higher than a predetermined value, the printer 12 can reduce the noise which appears on the image caused by the high sensitivity.

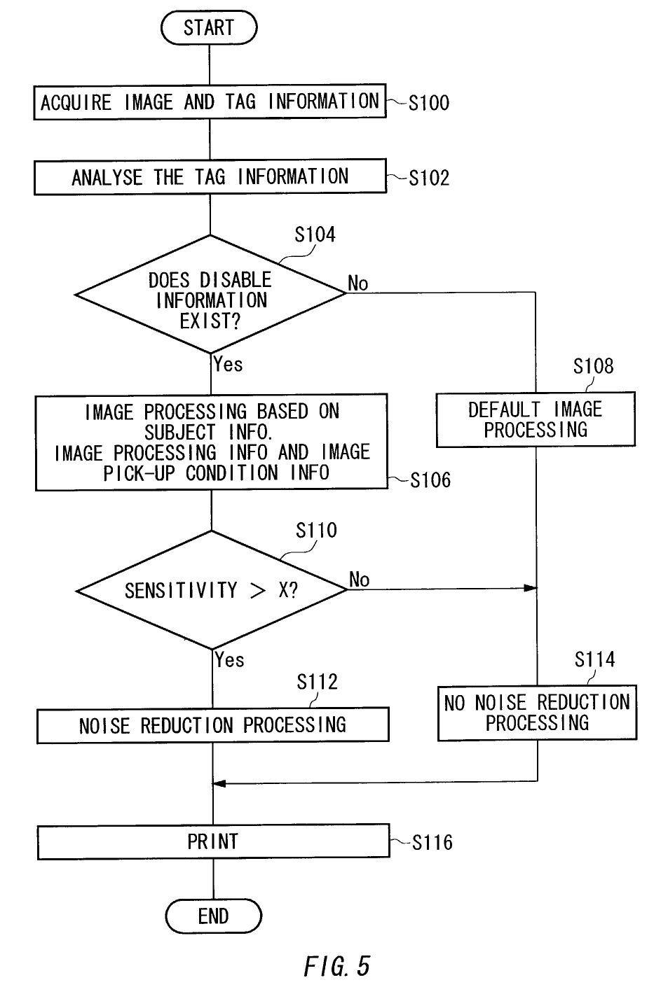

FIG. 5 is a flow chart showing an example of operation of the printer 12 according to the present embodiment. First, the acquisition unit 300 acquires the image, the tag information including the subject information, the image processing information, the image pick-up condition information, and the disable information, all of which are associated with each other (S100). Next, the control unit 304 analyzes the tag information acquired by the acquisition unit 300 (S102). Next, the control unit 304 judges, based on the disable information, whether to disable the image processing based on the subject information, the image processing information, and the image pick-up condition information, which are acquired by the acquisition unit 300 (S104). If the disable informational lows to perform image processing based on the subject information, the image processing information, and the image pick-up condition information in S104, the control unit 304 controls the image processing unit 302 to perform default image processing, which is preset in the printer 12, and the image processing unit 302 performs image processing based on the directions of the control unit 304 (S108). Next, the control unit 304 controls the noise reduction processing unit 308 not to perform noise reduction processing on the image, and the noise reduction processing unit 308 does not perform noise reduction processing based on the directions of the control unit 304 (S114). Next, the printing unit 310 converts the image, on which the image processing is performed by the image processing unit 302, into the data format for printing, and prints the image (S116). The sequential function flow of the operation of the printer 12 in this example is ended hereinbefore.

If the disable information disables to perform image processing based on the subject information, the image processing information, and the image pick-up condition information in S104, the control unit 304 determines the processing level of the image processing performed by the image processing unit 302 based on the subject information, the image processing information and the image pick-up condition information, and the image processing unit 302 performs image processing based on the directions of the control unit 304 (S106). Next, the control unit 304 judges whether the sensitivity is higher than a predetermined value, the sensitivity being indicated in the sensitivity information which is included in the image pick-up condition information acquired by the acquisition unit 300 (S110). If the sensitivity, indicated in the sensitivity information in S110, is higher than the predetermined value, the control unit 304 controls the noise reduction processing unit 308 to perform noise reduction processing on an image, and the noise reduction processing unit 308 performs noise reduction processing based on directions of the control unit 304 (S112). If the sensitivity, indicated in the sensitivity information in S110, is not higher than the predetermined value, the control unit 304 controls the noise reduction processing unit 308 not to perform noise reduction processing on the image, and the noise reduction processing unit 308 does not perform noise reduction processing based on the directions of the control unit 304 (S114). Next, the printing unit 310 converts the image into the data format for printing, the image on which the image processing being performed by the image processing unit 302, or the image processing and the noise reduction processing being performed by the image processing unit 302 and the noise reduction processing unit 308 respectively, and prints the image (S116). The sequential function flow of the operation of the printer 12 in this example is ended hereinbefore.

In this example, although the noise reduction processing unit 308 performs noise reduction processing on the image after the image processing unit 302 performs image processing on the image, the image processing unit 302 may perform image processing on the image after the noise reduction processing unit 308 performs noise reduction processing on the image in another example.

In another example of the image processing system of the present embodiment, the image processing system may include a displaying apparatus, such as a CRT, a liquid crystal display, a plasma display, various types of electronic papers, or an organic electroluminescence display, instead of the printer 12. The displaying apparatus, such as a CRT, a liquid crystal display, a plasma display, various types of electronic papers, or an organic electroluminescence display, is an example of the image processing apparatus. The displaying apparatus of this example includes an acquisition unit, an image processing unit, a control unit, a subject identification unit, a noise reduction processing unit, and a displaying unit. Explanation of the operation of the acquisition unit, the image processing unit, the control unit, the subject identification unit, and the noise reduction processing unit, which are included in the displaying apparatus, is omitted since the operation of each of the unit is the same as the operation of the acquisition unit 300, the image processing unit 302, the control unit 304, the subject identification unit 306, and the noise reduction processing unit 308 respectively, which are included in the printer 12 explained in FIGS. 4 and 5. The displaying unit of the displaying apparatus converts the image into the data format for displaying and displays the image, on which the image processing being performed by the image processing unit, or on which the image processing and the noise reduction processing being performed by the image processing unit and the noise reduction processing unit.

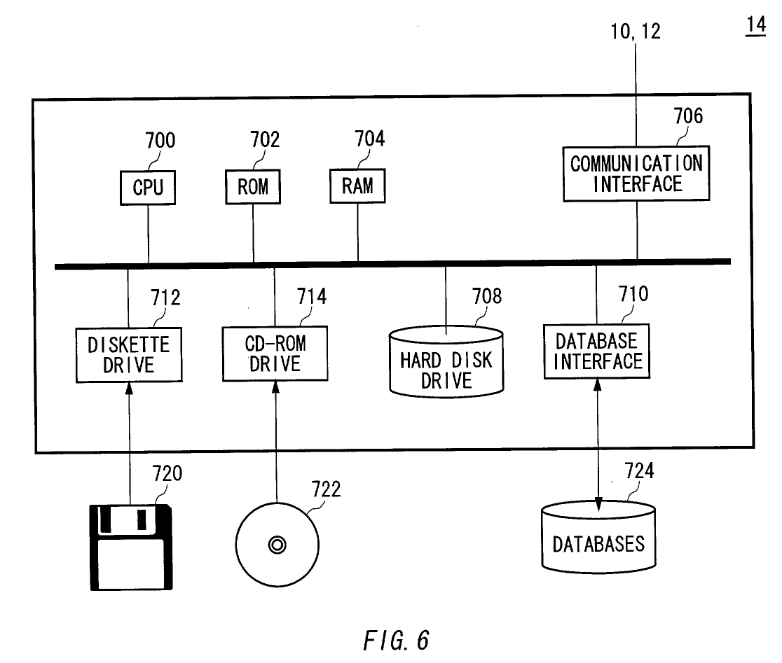

FIG. 6 is a block diagram showing an example of a hardware configuration of the personal computer 14 according to the present embodiment. The personal computer 14 includes CPU 700, ROM 702, RAM 704, a communication interface 706, a hard disk drive 708, a database interface 710, a diskette drive 712, and a CD-ROM drive 714. The CPU 700 operates based on a program stored in the ROM 702 and the RAM 704, and controls each unit. The personal computer 14 communicates with the digital camera 10 and the printer 12 through the communication interface 706. The database interface 710 writes data in a database, and updates the contents of the database.

The diskette drive 712 reads data or a program in a diskette 720, and provides the data or the program to the communication interface 706. The CD-ROM drive 714 reads data or a program in CD-ROM 722, and provides the data or the program to the communication interface 706. The communication interface 706 transmits the data or the program provided by the diskette drive 712 or the CD-ROM drive 714 to the digital camera 10 or the printer 12. The database interface 710 connects with various databases 724, and transmits and receives data to/from the databases 724.

The program for the printer 12 is provided by a user, being stored in a record medium such as the diskette 720 or the CD-ROM 722. The program stored in the record medium may be either compressed or decompressed. The program is read from the record medium, installed in the digital camera 10 or the printer 12 through the communication interface 706, and executed in the digital camera 10 or the printer 12.

The program in the record medium, which is installed in the digital camera 10, includes an image pick-up module, an image pick-up condition judging module, a storing module, an image processing module, a conversion module, a subject identification module, and an output module as a functional configuration. Since the function of the modules, by which the digital camera 10 is manipulated, is the same as the operation of the corresponding component in the digital camera 10 explained by FIGS. 1 to 5, explanation of the function of the modules is omitted.

The program in the record medium, which is installed in the printer 12, includes an acquisition module, an image processing module, a control module, a subject identification module, a noise reduction processing module, and a printing module as a functional configuration. Since the function of the modules, by which the printer 12 is manipulated, is the same as the operation of the corresponding component in the printer 12 explained by FIGS. 1 to 5, explanation of the function of the modules is omitted.

A part or all functions of the operation of the digital camera 10 or the printer 12 in the present embodiment explained in this patent application are storable in the diskette 720 or the CD-ROM 722, which are examples of the record media depicted in FIG. 6.

These programs may be read from the record medium and be executed directly by the digital camera 10 or the printer 12, or may be executed after the programs are installed in the digital camera 10 or the printer 12. The programs may be stored either on a single record medium or a plurality of record media. The programs may be stored in an encoded form.

It is possible to use an optical record medium such as DVD or PD, a magneto-optical record medium such as Minidisk, a tape medium, a magnetic record medium or a semiconductor memory such as an IC card or a Miniature Card as a record medium instead of the diskette or the CD-ROM. A storage device, such as a hard disk or RAM in a server system on a dedicated communication network or the Internet, may be used as a record medium and the program may be provided to the digital camera 10 or the printer 12 via the communication network.

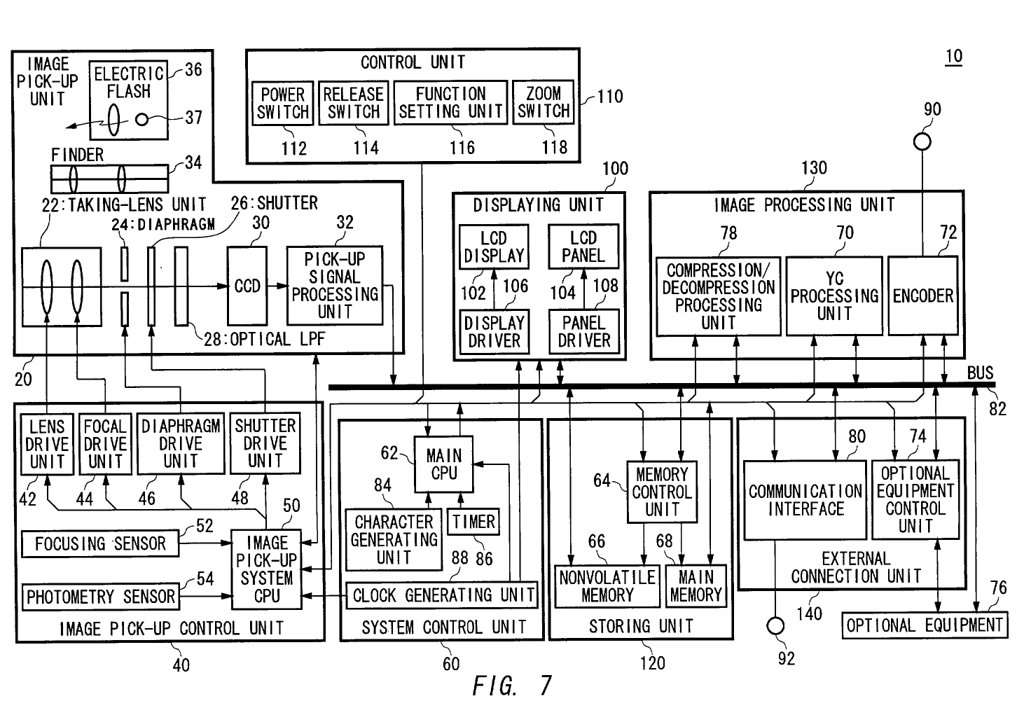

FIG. 7 is a block diagram showing an example of a detailed configuration of the digital camera 10 according to the present embodiment. The digital camera 10 includes the image pick-up unit 20, an image pick-up control unit 40, a system control unit 60, a displaying unit 100, a control unit 110, the storing unit 120, the image processing unit 130, and an external connection unit 140.

The image pick-up unit 20 includes a taking-lens unit 22, a diaphragm 24, a shutter 26, optical LPF 28 (low pass filter), CCD 30 (charge-coupled device), a pick-up signal processing unit 32, a finder 34, and a electric flash 36.

The taking-lens unit 22 takes and processes a subject image. The taking-lens unit 22 includes a focal lens, a zoom lens, etc., and forms the image of the subject onto surface of the CCD 30. The diaphragm 24 limits the light which passed the taking-lens unit 22, and the optical LPF 28 passes light having longer wavelength component than a predetermined wavelength. Each sensor element of the CCD 30 stores charge according to quantity of light of the formed subject image (the charge is referred to as “storedcharge” hereinafter).

The shutter 26 is a mechanical shutter and controls whether to form the image of the light onto the CCD 30, the light passing the taking-lens unit 22. The digital camera 10 may include an electronic shutter function instead of the mechanical shutter 26. In order to realize the electronic shutter function, the sensor element of the CCD 30 has a shutter gate and a shutter drain. The stored charge is discharged to the shutter drain by turning on the shutter gate. Time of storing the charge to each of the sensor, i.e., shutter speed, is controllable by controlling the shutter gate. In the CCD 30, the stored charge is read by a shift register by applying a readout gate pulse, and is read sequentially as a voltage signal by applying the register transfer pulse.

The pick-up signal processing unit 32 separates the voltage signal indicating the subject image outputted from the CCD 30, i.e., an analog signal, into R, G, and B components. The pick-up signal processing unit 32 adjusts white balance of the subject image by adjusting R, G, and B components. The pick-up signal processing unit 32 performs gamma correction of the subject image. The pick-up signal processing unit 32 converts the analog signal, which is separated into R, G, and B components, to a digital signal, and image data of the digital signal of the subject image (referred to as “digital image data” hereinafter), obtained by the A/D conversion, is outputted to the system control unit 60.

The finder 34 may have a displaying means and may display various information from below-mentioned main CPU 62, etc. The electric flash 36 includes a discharge tube 37, which discharges energy stored in a capacitor, and when the energy is supplied to the discharge tube 37, the electric flash 36 functions by the discharge tube 37 emitting light.

The image pick-up control unit 40 includes a lens drive unit 42, a focal drive unit 44, a diaphragm drive unit 46, a shutter drive unit 48, an image pick-up system CPU 50 which controls the drive units above, a focusing sensor 52, and a photometry sensor 54. The image pick-up system CPU 50 is an example of the image pick-up condition judging unit 200. The lens drive unit 42, the focal drive unit 44, the diaphragm drive unit 46, and the shutter drive unit 48 include driving means, such as a stepping motor, and drive mechanical components in the image pick-up unit 20. According to depression of a below-mentioned release switch 114, the focusing sensor 52 measures distance to the subject, and the photometry sensor 54 measures brightness of the subject. The focusing sensor 52 and the photometry sensor 54 supply focusing data and photometry data to the image pick-up system CPU 50, where the focusing data means the data of the measured distance to the subject, and the photometry data means the data of the measured brightness of the subject.

The image pick-up system CPU 50 controls the lens drive unit 42 and the focal drive unit 44, and adjusts a zoom magnification and a focus of the taking lens 22 based on photography information, such as a zoom magnification directed by a user. Alternatively, the image pick-up system CPU 50 may control the lens drive unit 42 and the focal drive unit 44, and may adjust a zoom magnification and a focus based on the focusing data received from the focusing sensor 52 and/or the photometry data received from the photometry sensor 54.

The image pick-up system CPU 50 determines stop and shutter speed based on an integral value of the R, G, and B digital signals in one image frame, i.e., automatic exposure (AE) information. The diaphragm drive unit 46 and the shutter drive unit 48 control the aperture size of the diaphragm 24, and the opening and closing of the shutter 26 according to the determined value.

The image pick-up system CPU 50 controls light emission of the electric flash 36 based on the photometry data, and adjusts the aperture size of the diaphragm 26 simultaneously. When the user instructs to take an image, the CCD 30 starts to store the charge and outputs the stored charge to the pick-up signal processing unit 32 after the shutter time calculated from the photometry data is elapsed.

The system control unit 60 includes main CPU 62, a character generating unit 84, a timer 86, and a clock generating unit 88. The main CPU 62 controls entire parts of the digital camera 10, especially the system control unit 60. The main CPU 62 sends and receives required information to/from the image pick-up systems CPU 50 by serial communication or the like.

The clock generating unit 88 generates an internal clock of the main CPU 62, and supplies it to the main CPU 62. The clock generating unit 88 also generates internal clocks of the image pick-up system CPU 50 and the displaying unit 100. The clock generating unit 88 may supply the clocks having different frequencies to the main CPU 62, the image pick-up system CPU 50, and the displaying unit 100, respectively.

The character generating unit 84 generates text and graphic information, which is superimposed onto the photographed image, such as date/time or a title of the image. A timer 86 has backing of battery etc., counts time always, and supplies time information, such as information about the photographed date/time of the photographed image, to the main CPU 62 based on the counted value. It is preferable that the timer 86 counts time with the power supplied from the battery, even when main power supply of the digital camera is switched off. It is also preferable that the character generating unit 84 and the timer 86 are annexed to the main CPU 62.

The storing unit 120 includes a memory control unit 64, nonvolatile memory 66, and main memory 68. The memory control unit 64 controls the nonvolatile memory 66 and the main memory 68. The nonvolatile memory 66 is composed of EEPROM (electrically erasable programmable read only memory) or flash memories etc., and stores it with data which is to be held even when the power supply of the digital camera 10 is switched off, such as setting information set by a user or a factory preset value. The nonvolatile memory 66 may store a boot program, a system program, etc. of the main CPU 62.

It is preferable that the main memory 68 is composed of memory which is relatively inexpensive and has large capacity, like DRAM. The main memory 68 has a function as frame memory to store the data outputted from the image pick-up unit 20, a function as system memory which loads various programs, and a function as a work area. The nonvolatile memory 66 and the main memory 68 communicate with each part inside/outside the system control unit 60 through a bus 82. The nonvolatile memory 66 may further store the digital image data.

The image processing unit 130 includes an YC processing unit 70, an encoder 72, and a compression/decompression processing unit 78. The external connection unit 140 includes an optional equipment control unit 74 and a communication interface 80. The encoder 72, the optional equipment control unit 74, and the communication interface 80 are examples of the output unit 202.

The YC processing unit 70 performs YC conversion to the digital image data, and generates a luminance signal Y, a color difference signals B-Y and R-Y. The main memory 68 stores the luminance signal and the color difference signals based on control of the memory control unit 64.

The compression/decompression processing unit 78 reads and compresses the luminance signal and the color difference signals sequentially from the main memory 68. Then the optional equipment control units 74 writes the compressed digital image data (referred to as “compressed data”) in a memory card which is an example of the optional equipment 76.

The encoder 72 converts the luminance signal and the color difference signals into a video signal (NTSC or PAL signal), and outputs the video signal from a terminal 90. When generating the video signal from the compressed data recorded on the optional equipment 76, the compressed data is supplied to the compression/decompression processing unit 78 at first through the optional equipment control unit 74. Then, the data is decompressed in the compression/decompression processing unit 78 and the encoder 72 converts the decompressed data into the video signal.

The optional equipment control unit 74 performs generation, logical conversion, and/or voltage conversion of the signal that flows between the bus 82 and the optional equipment 76, in order to conform the signal to the specification of the optional equipment 76 and the bus 82. Other than the above-mentioned memory card, the digital camera 10 may support a standard PCMCIA I/O card, for example, as the optional equipment 76. In this case, the optional equipment control unit 74 may be composed of bus control LSI for PCMCIA standard or the like.

The communication interface 80 performs control such as protocol conversion to comply with the communication specification supported by the digital camera 10, e.g., USB, RS-232C, Ethernet, etc. The communication interface 80 may output the compressed data or the digital image data to external equipment or to a network through a terminal 92. The communication interface 80 includes a driver IC if necessary and communicates with an external equipment through the terminal 92. The communication interface 80 may communicate with the external equipment, such as a printer, a karaoke machine or a video game machine, through an original standard interface.

The displaying unit 100 includes an LCD display 102, an LCD panel 104, a display driver 106, and a panel driver 108. The display driver 106 controls the LCD display 102. The panel driver 108 controls the LCD panel 104. The LCD display 102 is positioned on the back face of the camera, of which the size is about 2 inches for example, and displays an image currently photographed, a playback image, zoom magnification of the photographed or playback image, remaining battery charge, date/time, mode selection screen, a subject image, etc. The LCD panel 104 is a monochrome LCD, for example, is positioned on top face of the camera, and displays information, such as quality of the image (fine, normal, basic, etc.), flash mode (forced flash, suppressed flash, etc), number of available frames, number of pixels, and remaining battery charge.

The control unit 110 includes a power switch 112, a release switch 114, a function setting unit 116, and a zoom switch 118. The power switch 112 switches the digital camera 10 on and off based on direction of a user. The release switch 114 can be depressed in two levels, i.e., halfway depression and full depression. For example, when the release switch 114 is depressed halfway, the image pick-up control unit 40 performs automatic focusing and automatic exposure, and the image pick-up unit 20 picturizes a subject image by depressing the release switch 114 fully.

The function setting unit 116 is, for example, a rotatable mode dial or a 4-direction button and accepts settings such as “file format”, “special effect”, “print”, “determine/save”, “change display”, etc. The zoom switch 118 accepts setting of zoom magnification of the subject image picturized by the image pick-up unit 20.

The digital camera 10 having the above-mentioned structure operates in the following manner. First, the power switch 112 is depressed and power is supplied to each part of the digital camera 10. The main CPU 62 judges whether the digital camera 10 is in photography mode or in playback mode by reading status of the function setting unit 116.

When a digital camera 10 is in photography mode, the main CPU 62 supervises the depression status of the release switch 114. When the half-depression of the release switch 114 is detected, the image pick-up system CPU 50 acquires photometry data and focusing data from the photometry sensor 54 and the focusing sensor 52, respectively. The image pick-up control unit 40 adjusts focus and stop of the image pick-up unit 20, etc. based on the photometry data and the focusing data acquired by the image pick-up system CPU 50. After the adjustment, the LCD display 102 informs a user about the completion of the adjustment by displaying characters, such as “standby”.

Then, the main CPU 62 supervises the depression status of the release switch 114. When the full-depression of the release switch 114 is detected, the shutter 26 is closed after a predetermined shutter time is elapsed and the stored charge of the CCD 30 is discharged to the pick-up signal processing unit 32. The digital image data, generated as a result of processing by the pick-up signal processing unit 32, is outputted to the bus 82. The digital image data is once stored in the main memory 68, then it is processed in the YC processing unit 70 and the compression/decompression processing unit 78, and is recorded in the optional equipment 76 via the optional equipment control unit 74. The photographed image based on the recorded digital image data is displayed on the LCD display 102 for a while, so that a user can check the photographed image. As described above, a sequence of the photographing operation is finished.

On the other hand, when the digital camera 10 is in playback mode, the main CPU 62 reads the photographed image from the main memory 68, the nonvolatile memory 66, and/or the optional equipment 76, and displays the image on the LCD display 102 of the displaying unit 100.

In this state, when a user directs either “move forward” or “move backward” on the function setting unit 116, the main CPU 62 reads another photographed image stored in the main memory 68, the nonvolatile memory 66, and/or the optional equipment 76, and displays the image on the LCD display 102 of the displaying unit 100.

As described above, the present invention provides the image processing system which appropriately performs image processing on an image picturized by the image pick-up apparatus.

Although the present invention has been described by way of an exemplary embodiment, it should be understood that those skilled in the art might make many changes and substitutions without departing from the spirit and the scope of the present invention which is defined only by the appended claims.

What is claimed is:

1. An image processing system comprising:
an image pick-up apparatus which picturizes an image of a subject, comprises:
an image pick-up unit which picturizes an image of the subject;
an image processing unit which performs image processing on the image;
a storing unit which stores processing level of the image processing in association with the image, the image processing being performed by said image processing unit; and
an output unit which outputs the image and the processing level in association with the image to the image processing apparatus; and
an image processing apparatus which performs image processing on the image picturized by the image pick-up apparatus, comprising:
an acquisition unit which acquires the image and the processing level in association with the image from the image pick-up apparatus;
an image processing unit which performs image processing on the image; and
a control unit which controls processing level of image processing performed by said image processing unit based on the processing level of image processing performed by the image pick-up apparatus.

2. An image pick-up apparatus which picturizes an image of a subject, comprising:
an image pick-up unit which picturizes the image of the subject;
an image processing unit which performs image processing on the image; and
a storing unit which stores processing level of the image processing in association with the image, the image processing being performed by said image processing unit.

3. The image pick-up apparatus as claimed in claim 2, wherein said image processing unit performs at least one processing of a contrast enhancement, a color gain correction, and a sharpness enhancements on the image, and said storing unit stores at least one of the processing level of the contrast enhancement, the color gain correction, and the sharpness enhancement, in association with the image, the image processing being performed by said image processing unit.

4. The image pick-up apparatus as claimed in claim 3, further comprising a conversion unit which converts the processing level of the contrast enhancement and a color gain correction, performed by said image processing unit, into gamma correction level of the image, wherein said storing unit stores the gamma correction level as the processing level of the contrast enhancement and the color gain correction performed by said image processing unit.

5. The image pick-up apparatus as claimed in claim 2, further comprising a subject identification unit which identifies classification of the subject, wherein said storing unit further stores the classification of the subject, identified by said subject identification unit, in association with the image.

6. The image pick-up apparatus as claimed in claim 2, further comprising an image pick-up condition judging unit which judges image pick-up conditions when said image pick-up unit picturizes the image, wherein said storing unit further stores image pick-up condition information, which indicates the image pick-up conditions judged by said image pick-up condition judging unit, in association with the image.

7. The image pick-up apparatus as claimed in claim 6, wherein said image pick-up condition judging unit acquires the sensitivity of said image pick-up unit as the image pick-up conditions, and said storing unit further stores sensitivity information, which indicates the sensitivity acquired by said image pick-up condition judging unit, in association with the image.

8. The image pick-up apparatus as claimed in claim 2, further comprising an output unit which outputs the image and the processing level in association with the image.

9. An image processing apparatus which performs image processing on an image picturized by an image pick-up apparatus, comprising:
an acquisition unit which acquires the image and processing level of image processing in association with the image, the image processing being performed on the image by the image pick-up apparatus;
an image processing unit which performs image processing on the image; and
a control unit which controls processing level of image processing performed by said image processing unit based on the processing level of image processing performed by the image pick-up apparatus.

10. The image processing apparatus as claimed in claim 9, wherein said acquisition unit acquires at least one processing level of a contrast enhancement, a color gain correction, and a sharpness enhancement, which is performed on the image by the image pick-up apparatus.

11. The image processing apparatus as claimed in claim 9, wherein if the processing level acquired by said acquisition unit is lower than a predetermined processing level, and said control unit enlarges the processing level of image processing performed by said image processing unit.

12. The image processing apparatus as claimed in claim 9, wherein said acquisition unit further acquires classification of a subject of the image in association with the image, and said control unit controls the processing level of image processing performed by said image processing unit further based on the classification of the subject.

13. The image processing apparatus as claimed in claim 9, further comprising a subject identification unit which identifies the classification of a subject of the image, wherein said control unit controls the processing level of image processing performed by said image processing unit further based on the classification of the subject identified by said subject identification unit.

14. The image processing apparatus as claimed in claim 9, wherein said acquisition unit further acquires image pick-up condition information in association with the image, the image pick-up condition indicating image pick-up conditions when the image is picturized by the image pick-up apparatus, and said control unit controls the processing level of image processing performed by said image processing unit further based on the image pick-up condition information.

15. The image processing apparatus as claimed in claim 9, further comprising a printing unit which prints the image on which image processing is performed by said image processing unit.

16. The image processing apparatus as claimed in claim 9, further comprising a displaying unit which displays the image on which image processing is performed by said image processing unit.

17. An image processing apparatus which performs image processing on an image picturized by an image pick-up apparatus, comprising:
an image processing unit which performs image processing on the image;
a subject identification unit which identifies classification of a subject of the image, and
a control unit which controls processing level of image processing performed by said image processing unit based on the classification of the subject identified by said subject identification unit.

18. The image processing apparatus as claimed in claim 17, wherein said subject identification unit identifies classification of a main subjects of the image, and said control unit controls the processing level of image processing performed by said image processing unit based on the classification of the main subjects identified by said subject identification unit.

19. An image processing apparatus which performs image processing on an image picturized by an image pick-up apparatus, comprising:
an acquisition unit which acquires the image and sensitivity information in association with the image, the sensitivity information indicating sensitivity of the image pick-up apparatus when the image is picturized; and
a noise reduction processing unit which performs noise reduction processing on the image based on the sensitivity information.

20. The image processing apparatus as claimed in claim 19, wherein if the sensitivity, indicated in the sensitivity information acquired by said acquisition unit acquired, is higher than a predetermined value, and said noise reduction processing unit performs noise reduction processing on the image.

21. An image processing method which performs image processing on an image picturized by an image pick-up apparatus, comprising steps of:
acquiring the image and processing level of image processing in association with the image, the image processing being performed on the image by the image pick-up apparatus;
performing image processing on the image and;
controlling processing level of image processing performed in said performing step based on the processing level of image processing performed by the image pick-up apparatus.

22. An image processing method which performs image processing on an image picturized by an image pick-up apparatus, comprising steps of:
performing image processing on the image;
identifying classification of a subject of the image, and
controlling processing level of image processing performed in said performing step based on the classification of the subject identified in said identifying step.

23. An image processing method which performs image processing on an image picturized by an image pick-up apparatus, comprising steps of:
acquiring the image and sensitivity information in association with the image, the sensitivity information indicating sensitivity of the image pick-up apparatus when the image is picturized; and
performing noise reduction processing on the image based on the sensitivity information.

24. A computer readable medium storing thereon a program for an image pick-up apparatus which picturizes an image of a subject, the program comprising:
an image pick-up module which allows the image pick-up apparatus to picturize an image of the subject;
an image processing module which allows the image pick-up apparatus to perform image processing on the image; and
a storing module which allows the image pick-up apparatus to store processing level of image processing in association with the image, the image processing being performed by said image processing module.

25. A computer readable medium storing thereon a program for an image processing apparatus which performs image processing on an image picturized by an image pick-up apparatus, the program comprising:
an acquisition module which allows the image processing apparatus to acquire the image and processing level of image processing in association with the image, the image processing being performed on the image by the image pick-up apparatus;
an image processing module which allows the image processing apparatus to perform image processing on the image and;
a control module which allows the image processing apparatus to control processing level of image processing performed by said image processing module based on the processing level of image processing performed by the image pick-up apparatus.

26. A computer readable medium storing thereon a program for an image processing apparatus which performs image processing on an image picturized by an image pick-up apparatus, the program comprising:
an image processing module which allows the image processing apparatus to perform image processing on the image;
a subject identification module which allows the image processing apparatus to identify classification of a subject of the image; and
a control module which allows the image processing apparatus to control processing level of image processing performed by said image processing module based on the classification of the subject identified by said subject identification module.

27. A computer readable medium storing thereon a program for an image processing apparatus which performs image processing on an image picturized by an image pick-up apparatus, the program comprising:
an acquisition module which allows the image processing apparatus to acquire the image and sensitivity information in association with the image, the sensitivity information indicating sensitivity of the image pick-up apparatus when the image is picturized; and
a noise reduction processing module which allows the image processing apparatus to perform noise reduction processing on the image based on the sensitivity information.
